(19) United States
(12) Patent Application Publication
(10) Pub. No.: US 2007/0063823 A1
(43) Pub. Date: Mar. 22, 2007

(54) Burglarproof apparatus

(76) Inventor: Ko-Cheng Fang, Danshui Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/229,635

(22) Filed: Sep. 20, 2005

(51) Int. Cl. B60R 25/10

(52) U.S. Cl. 340/426.1; 340/901

(57) ABSTRACT

A burglarproof apparatus is provided, wherein the apparatus includes a processing means and a transceiver, and the transceiver is connected to and used for controlling an engine. The processing means and the transceiver are connected without any wires, and the processing means is used to transmit signals to the transceiver for controlling the engine. In addition, the processing means is identified by an identification code. By using the identification code, a user can control the processing means to set a password, after which when the user inputs the password to the processing means, the user can use the processing means to start the engine. On the other hand, if an incorrect password is input into the processing means, the engine cannot be started by the processing means.

### FIELD OF THE INVENTION

The present invention is about a burglarproof apparatus, and more particularly is about a burglarproof apparatus for vehicles.

### BACKGROUND OF THE INVENTION

Today, a vehicle is very necessary for people in daily life. However, vehicles are very expensive and often targeted by thieves to steal.

When a burglar breaks a door lock of a vehicle and successfully gets into the vehicle, the burglar can disable the ignition lock and turn the ignition switch to the starter to fire up the engine. The burglar can alternatively hot-wire the ignition system or use a duplicate key to turn the ignition switch.

Typically, an alarm system is installed in a vehicle to protect this vehicle from being stolen. However, such an alarm system has to be connected to power. If the connection between the power and the alarm system is cut, the alarm system may not work normally for preventing an intruder.

Therefore, a system that can resolve the foregoing problem is required.

### SUMMARY OF THE INVENTION

Accordingly, a burglarproof apparatus is provided that includes a processing means and a transceiver. The transceiver is connected to and used for controlling an engine. The processing means and the transceiver are connected without any wires, and the processing means is used to transmit signals to the transceiver for controlling the engine. In addition, the processing means is identified by an identification code. By using the identification code, a user can control the processing means to set a password, wherein after the user inputs the password to the processing means, the user can use the processing means to start the engine. On the other hand, if an incorrect password is input into the processing means, the engine cannot be started by the processing means.

This burglarproof apparatus disclosed in the present invention can improve the efficiency of guarding against burglary.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of the burglarproof apparatus disclosed in the present invention.

### DETAILED DESCRIPTION OF THE PREFERRED EMBODIMENT

Typically, the ignition switch, the starter and the engine in a vehicle are connected together by wires. Therefore, a burglar can start the engine as long as the ignition switch, the starter and the engine are successfully connected. The present invention is to build a new connection relationship among the ignition switch, the starter and the engine to improve the efficiency to guard against burglary.

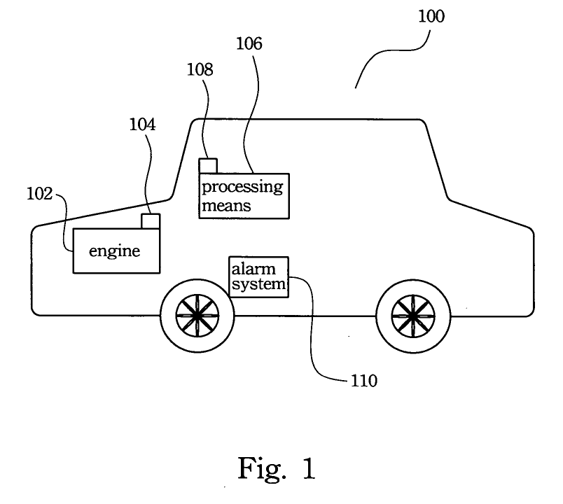

FIG. 1 illustrates a schematic diagram of the burglarproof apparatus disclosed in the present invention. Referring to FIG. 1, the burglarproof apparatus is used in a car 100. The burglarproof apparatus includes a processing means 106 and a transceiver 104. The transceiver 104 is connected to and used for controlling an engine 102, such as an automobile engine. The communication between the processing means 106 and the transceiver 104 is wireless. A transceiver 108 is installed in the processing means 106 to transmit signals to the transceiver 104 for controlling the engine 102. In an embodiment, the processing means 106 is a computer that can process a program to control the engine 102.

The processing means 106 is identified by an identification code. By using the identification code, a user can control the processing means 106. For example, the user can input this identification code to the processing means 106 so as to control and operate the processing means 106. According to this present invention, each processing means has a unique identification code. Only the owner, the fabricator and informed persons know this identification code of this processing means. Therefore, it is not easy for a person to sell an illegally obtained processing means.

When a user uses this processing means 106, he can set a password first. This password can be changed by the user when desired. After the user inputs the password to the processing means 106, the user can use the processing means 106 to start the engine 102. On the other hand, if an incorrect password is input into the processing means 106 by the user, the engine 102 cannot be started by the processing means 106.

According to this embodiment, there is no electrical wiring among the processing means 106, the transceiver 104 and the engine 102. Therefore, it is impossible for a burglar to start this engine 102 by a conventional method such as hot-wiring. In other words, only the processing means 106 can start the engine 102. If the burglar does not know the password and the identification code, it is impossible for the burglar to use this processing means 106 to start this engine 102. Therefore, the burglar cannot drive the car 100. Such a method can prevent the car 100 from being stolen.

Moreover, in other embodiments, if a wrong password or alternatively if no password is input into the processing means 106 of the car 100, and the car 100 is moved a certain distance, the processing means 106 sends out an alarm signal to notify the owner of this situation. password

The password may be changed by the user when desired to ensure that the password is kept secret. Moreover, because each processing means has a unique password, a burglar has to resolve the password first and then use this code to control the processing means. This is very difficult for a burglar.

In other words, the present invention can improve the efficiency of guarding against burglary.

Moreover, an alarm system may be installed into the burglarproof apparatus to further improve its efficiency. When a wrong password is input into the processing means 106, the alarm system is triggered to send out an audible signal to notify the owner. Moreover, a tracing and locating apparatus (not shown in this FIGURE) can also be installed into the burglarproof apparatus. For example, the locating apparatus is a global positioning system (GPS). In this embodiment, if a wrong password or no password is input into the processing means 106 of the car 100, and the car 100 is moved a certain distance, the locating apparatus is triggered to send out the location information of the car to the police to trace. Moreover, a software also can be used to realize the tracing and locating apparatus in the processing means.

Accordingly, the burglarproof apparatus of the present invention can improve the efficiency of guarding against burglary.

As is understood by a person skilled in the art, the foregoing descriptions of the preferred embodiments of the present invention are illustrations of the present invention rather than limitations thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. A burglarproof apparatus, comprising:
a transceiver coupling with an engine and controlling said engine; and
a processing means, wherein a wireless connection is used between said processing means and said transceiver, said processing means sends a signal to said transceiver to control said engine, and said processing means has an identification code, wherein a user can use said identification code to control said processing means and set a password.

2. The apparatus according to claim 1, wherein when said password is input into said processing means, said user can use said processing means to start said engine.

3. The apparatus according to claim 1, wherein when a wrong password is input into said processing means, said user cannot use said processing means to start said engine.

4. The apparatus according to claim 1, wherein said processing means is a computer.

5. The apparatus according to claim 1, wherein said engine is a car engine.

6. The apparatus according to claim 1, further comprising a locating system, wherein when a wrong password or no password is input into said processing means and said engine is moved a certain distance, said locating system is triggered to send out a signal for tracing said engine.

7. The apparatus according to claim 6, wherein said locating system is a software program.

8. The apparatus according to claim 1, further comprising an alarm system, wherein when a wrong password is input into said processing means, the alarm system is triggered.

9. The apparatus according to claim 1, wherein when a wrong password is input into said processing means, said processing means sends out a signal to alert people.

10. The apparatus according to claim 1, wherein when a wrong password or no password is input into said processing means and said engine is moved a certain distance, said processing means sends out a signal to alert people.

11. The apparatus according to claim 1, wherein said processing means further comprises a second transceiver for transmitting a signal to said transceiver.

12. The apparatus according to claim 1, wherein said processing means uses a software to control said engine.

13. A burglarproof apparatus, comprising:
a first transceiver coupling with an engine and controlling said engine; and
a processing means with a second transceiver, wherein a wireless connection is used between said processing means and said first transceiver, said processing means sends a signal to said transceiver to control said engine by said second transceiver, and said processing means has an identification code, wherein a user can use said identification code to control said processing means and set a password.

14. The apparatus according to claim 13, wherein when said password is input into said processing means, said user can use said processing means to start said engine.

15. The apparatus according to claim 13, wherein when a wrong password is input into said processing means, said user cannot use said processing means to start said engine.

16. The apparatus according to claim 13, wherein said processing means is a computer.

17. The apparatus according to claim 13, further comprising an locating system, wherein when a wrong password or no password is input into said processing means and said engine is moved a certain distance, said locating system is triggered to send out a signal for tracing said engine.

18. The apparatus according to claim 17, wherein said locating system is a software program.

19. The apparatus according to claim 13, further comprising an alarm system, wherein when a wrong password is input into said processing means, the alarm system is triggered.

20. The apparatus according to claim 13, wherein when a wrong password is input into said processing means, said processing means sends out a signal to alert people.

21. The apparatus according to claim 13, wherein when a wrong password or no password is input into said processing means and said engine is moved a certain distance, said processing means sends out a signal to alert people.

22. The apparatus according to claim 13, wherein said processing means uses a software to control said engine.
